(19) United States
(12) Patent Application Publication
(10) Pub. No.: US 2010/0031526 A1
(43) Pub. Date: Feb. 11, 2010

(54) DRYER

(75) Inventor: Steven Lewis Tuckett, Altona (AU)

Correspondence Address: VOLPE AND KOENIG, P.C., UNITED PLAZA, SUITE 1600, 30 SOUTH 17TH STREET, PHILADELPHIA, PA, 19103, US

(73) Assignee: ECO-DRY SYSTEMS PTY LTD, St. Kilda, VI (AU)

(21) Appl. No.: 12/438,959

(22) PCT Filed: Apr. 17, 2008
(86) PCT No.: PCT/AU2008/000536

§ 371 Date: Feb. 26, 2009

(30) Foreign Application Priority Data
Apr. 20, 2007 (AU) 2007902065

(51) Int. Cl. F26B 19/00; F26B 25/08

(52) U.S. Cl. 34/60; 34/215

(57) ABSTRACT

A dryer has a motorized air blower for providing a stream of air, an ozoniser for providing ozone in the stream of air, a heater for heating the stream of air after a start up period during which the stream of air mixed with ozone is unheated, a nozzle assembly, each nozzle in the assembly having an outlet, and ducting for directing the stream of air into the nozzle assembly so that the stream of air exits each nozzle through its outlet.

### FIELD OF THE INVENTION

This invention relates to methods of drying and dryer constructions for carrying out such methods. It relates particularly but not exclusively to dryers which may be used for drying shoes, boots, or gloves, especially ski boots or ski gloves whilst treating them with a treatment agent.

### BACKGROUND OF THE INVENTION

Electrical dryers of various constructions are used in numerous situations where the natural drying approach involving allowing articles to stand in the open air and dry at room temperature is impractical, by virtue of restrictions on time or space.

Dryers are particularly employed where there is a need for a high drying turnover. For example, in the ski hire industry, ski boots which have been hired out for a day or longer are returned to the hirer in wet and smelly condition. Generally speaking, the hirer will place the boots on a drying rack for drying overnight ready to be offered for hire to a new customer the next day. Often, because of the difficulty of drying such boots properly in the limited time available, the boots are rehired whilst they are still moist. Even if the hirer manages to dry the boots completely, there is often an undesirable residual odour associated with the boots.

Ski gloves also present difficulties for skiers as they can become moist through perspiration and/or melted snow. When this happens they become uncomfortable and cold and there is an associated risk of frost-bite. Thus there is a need to rapid dry gloves whenever they become moist.

The invention seeks to provide dryer constructions which can be used for drying clothing such as boots or gloves.

### DISCLOSURE OF THE INVENTION

The invention provides in one aspect, a dryer comprising,
a motorised air blower for providing a stream of air,
an ozoniser for providing ozone in the stream of air,
a heater for heating the stream of air after a start up period during which the stream of air mixed with ozone is unheated,
a nozzle assembly, each nozzle in the assembly having an outlet, and
ducting for directing the stream of air into the nozzle assembly so that the stream of air exits each nozzle through its outlet.

The ozone may be injected into the stream of air downstream of the heater.

The dryer may include control means for controlling various parameters associated with the ozone generation and the cycle of the dryer. Such parameters may include temperature, the heater, rate of air flow, time for which flow occurs and rate of injection of ozone. The parameters may be different for different objects being dried eg. boots or gloves. The parameters may change during the treatment cycle. For example the degree of ozonisation of the stream of air may be greater during the initial cool start up period compared with the later heating period. It may be possible to cease ozonisation of the air stream prior to heating provided the initial cold ozonised air stream treatment is sufficient to substantially sterilise boots, gloves or other items of clothing.

In the case of boots, the control means may be associated with a temperature sensor. Typically, the control means may control temperature such that the heater does not begin heating the air stream until after a predetermined time. For example, the air stream may remain unheated for a period of between 1 and 30 minutes, more preferably between 2 and 10 minutes. It is preferable to commence the drying cycle with such a cold cycle commencement because it has been found that moisture in boots absorbs more ozone when it is cold than when it is warm. Thus, the rate of ozone absorption may be increased by maintaining the treatment stream at a cold temperature or room temperature during the first part of the cycle. Typically, the cold ozonisation process may proceed for about 3 minutes in the case of boots or less in the case of gloves.

After the cold ozonisation has been completed, heating may commence. It may continue for a predetermined period. For example, heating may be carried out for a period of between 5 and 60 minutes. More preferably, it may be carried out between 8 and 20 minutes. The temperature of heating will affect the period for which heating of the air stream occurs. In a typical process, heating may occur for about 12 minutes whilst the air stream is maintained at a temperature of about 57° C.

Suitably the ozonised air should be added downstream of the heating element to improve the effectiveness of the process. The heating element could otherwise act to break down the ozone during the heating cycle.

The control means may be adapted to turn off the motorised air blower, heater and ozoniser at the end of the heating cycle. In a particular embodiment, the fan may continue to run for a period after the heater has been switched off to dissipate excess heat. It may typically run for 10 to 60 seconds. In one particular aspect, it may run for about 20 seconds.

After this final phase, the dryer may switch off completely until it has been reset for a further cycle.

The heater may comprise an electrical heating element downstream of the motorised air blower.

The nozzle assembly may be presented in a removable frame. Thus, it may be possible to readily substitute different nozzle assemblies.

The nozzles may be arranged so that they point upwardly and can thus act as a hook which projects into a shoe, glove or boot and holds it in place.

The nozzles may be associated with valve means to cut off flow for those nozzles which are not in use.

Where the dryer is being used to dry gloves the nozzle assembly may comprise two nozzles. The nozzle assembly may comprise a grip member for holding a glove on each nozzle. The nozzle assembly may be provided in a closable cabinet.

The closable cabinet may have a door. The door may be motorised. It may be slidable between an open position when gloves can be placed on the nozzles and a closed position when the gloves are being dried.

There may be a sensor for detecting the presence of gloves on the nozzles. The dryer may be coin operated. It may typically dry and sterilise gloves for a period of between 1 minute and 10 minutes. More preferably, drying time may be between 2 minutes and 5 minutes. The initial sterilisation with ozone may occur without heating after which heating upstream of the ozoniser may occur. Typically, a period of 10 seconds to 120 seconds of cold sterilisation may occur before the heating and drying cycle.

The drying temperature may be in excess of 50° C. The drying air may be maintained at this temperature for substantially all the drying time of the drying cycle. The drying air may include ozone.

There may be a plurality of closable cabinets in a drying unit. For example, there may be four closable cabinets in a drying unit making it possible to dry four pairs of gloves simultaneously.

Each dryer may be associated with a microprocessor. The microprocessor may be arranged to record and/or transit information concerning operation of the dryer. For example, it may log the amount of money which has been collected via coin operation and various parameters relating to the correct functioning of the dryer. Such parameters may include any one or more of, correct functioning of the door, glove presence or absence, drying temperature, safety mechanisms, electricity supply, environmental temperature and coin operating mechanism.

The dryer may have a safety mechanism to sense obstructions preventing correct operation of the door.

The dryer may include transmission means to pass on information logged by the microprocessor to a remote location. The transmission means may comprise a cable connection such as a wired telephone connection or a radio connection such as a mobile phone dial up.

In another aspect, the invention provides an ozoniser comprising,
a tubular housing of circular cross section having inlet and outlet ends and a central axis,
an inlet tube for incoming oxygen containing gas at the inlet end of the housing,
an outlet tube for ozonised gas at the outlet end of the housing,
an internal core extending axially within the tubular housing to define with the tubular housing, an annular passageway for gas between the inlet tube and outlet tube, and
means for applying a high voltage across the annular passageway,
wherein the inlet is shaped so as to direct a stream of the incoming gas into the annular passageway, preferably at an angle of between 82° and 79° to the central axis.

The shaping and angle of the inlet suitably serves to cause gas flowing through the ozoniser to follow a spiral path through the annular passageway and around the central core.

The ozoniser may be associated with an air pump for blowing air through the ozoniser and injecting ozonised air into the treatment stream.

Electrodes for application of a high voltage across the annular passageway may be provided in the core and in association with the tubular housing.

The core electrode may extend along the axis of the core. The housing electrode may comprise a conductive tubular element surrounding the housing. It may comprise metal foil surrounding the housing.

The ozoniser may be mounted within an outer container. Insulation may be provided between the walls of the outer container and the ozoniser.

The ozoniser may include voltage application means. The voltage application means may apply an AC current across the ozoniser. The voltage application means may include means for varying the frequency of the applied voltage.

In this regard, applicants have found that varying the frequency across the ozoniser can be used as a means for controlling the ozone output. The amount of frequency variation and rate of change of ozone output will be variable depending upon the construction of the ozoniser.

However, in relation to applicant's ozoniser described in more detail hereinafter, applicants have found that ozone production versus frequency generally yields a bell curve graph with the resonant frequency being the peak of the bell curve.

Generally speaking, applicants have found that varying the frequency by plus or minus 25% is sufficient to give a large variation in ozone output. For example, the ozone output may be varied by 50% or even more. It is even possible to obtain substantial variation in ozone output by varying the frequency by plus or minus 10%.

In applicant's exemplified ozoniser, a typical resonant frequency has been found to be about 1,200 Hz. However it is to be understood that higher or lower resonant frequencies can be applicable for different ozoniser constructions. It may be particularly desirable in some instances to have a resonant frequency below 1,000 Hz so as to be below the radio frequency spectrum.

Preferred aspects of the invention will now be described with reference to the accompanying drawings.

### BRIEF DESCRIPTION OF THE DRAWINGS

FIG. 1 shows an isometric view of a dryer according to the invention;

FIG. 2 shows the cross section X-X taken through FIG. 1;

FIG. 3 shows a partially cut away isometric view of a blower assembly;

FIG. 4 shows an isometric view of the rear of the dryer assembly of FIG. 3;

FIG. 5 shows a fragmentary isometric partially exploded view of a nozzle assembly;

FIG. 6 shows an isometric view of a nozzle assembly;

FIG. 7 shows an isometric view of a nozzle assembly with more nozzles;

FIG. 8 shows an isometric view of a nozzle assembly with even more nozzles;

FIG. 9 shows a cross section of a fragmentary view of an alternative nozzle assembly;

FIG. 10 shows the nozzle assembly of FIG. 9 when not in use;

FIG. 11 shows a block diagram of the control system for the dryer;

FIG. 12 shows a partially cut away elevational view of an ozoniser according to the invention;

FIG. 13 shows a cross section taken through the ozoniser of FIG. 12;

FIG. 14 shows an isometric view of an alternative form of dryer according to the invention;

FIG. 15 shows a side on elevational view of the inside of one of the cabinets of the dryer of FIG. 14 prior to placement of a glove;

FIG. 15a shows a view equivalent to FIG. 15 after a glove has been placed and the cabinet closed;

FIG. 16 shows an isometric view of a nozzle assembly; and

FIG. 17 shows the cross-section Y-Y taken through the upper part of the nozzle assembly of FIG. 16 as well as a partially cut away section of the bottom portion.

### DETAILED DESCRIPTION OF THE PREFERRED EMBODIMENTS

The various elements identified by numerals in the drawings are listed in the following integer list.

### Integer List

1 Dryer

3 Housing

4 Pedestal

5 Inlet

7 Switch

8 Front wall

9 Nozzle assembly

10 Nozzle

11 Outlet

12 Mounting frame

13 Blower assembly

14 Blower

16 Blower inlet

17 Centrifugal fan

18 Motor

20 Heating chamber

22 Heating element

24 Mixing chamber

26 Ozoniser assembly

27 Circuit board

28 Ozoniser

29 Air pump

30 Supply tube

31 Split ducting

32 Split ducting

34 Perforated baffle

35 Cover

36 Rear ducting

38 Nozzle assembly

39 Stepped face

40 Lip

50 Mounting frame

52 Inlet

54 Socket

56 Nozzle

57 Outlet

58 Circular end

59 Inlet

60 Spring

70 Ozoniser

72 Tubular housing

74 Inlet

75 Wall

76 Outlet

77 Wall

79 Central core

80 Annular flow path

82 Conductive plastic foam

84 Conductive element

85 Conductive rod

86 High tension lead

87 High tension lead

89 Outer container

90 Insulation

100 Drying unit

102a, b, c, d Cabinet dryer

104 Glove

106 Nozzle assembly

108 Nozzle

110 Grip member

112 Pivot point

114 Roller wheel

116 Sliding door

118 Linear actuator

119 Frame assembly

120 Switch

121 Safety switch

122 Coin/note slot

123 Sliding arm

124 Display

125 Guide

126 Cover (silicone)

127 Base (silicone)

128 Chamber

130 Ozoniser

131 Plug

132 Tube

133 Plug

135 Electrical leads

137 Delivery tube

139 Neck

141 Ceramic heater

143 Fan

145 Air chamber

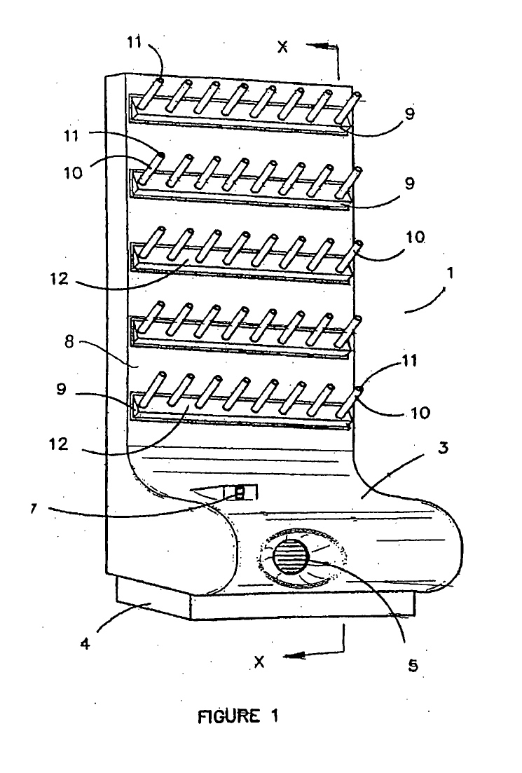

Referring to FIGS. 1 to 5 and 7 of the accompanying drawings, there is shown a dryer generally designed 1 comprising a housing 3 which rests on a pedestal 4.

The housing includes an inlet 5, shown more clearly in FIG. 1, through which air is sucked by a blower assembly 13.

The front of the housing includes a switch 7 for initiating a drying sequence.

The front wall 8 forming the vertically extending section of the dryer above the blower assembly includes a number of nozzle assemblies 9 each provided with a plurality of nozzles 10 having upwardly pointing outlets 11.

The nozzle assembly includes a mounting frame 12 having a rectangular circumferential lip 40 for purposes to become apparent. The mounting frame acts as a mount for the individual nozzles 10 forming the nozzle assembly.

The blower assembly 13 provided within the housing 3 includes a blower 14 having a blower inlet 16 and a centrifugal fan 17 powered by the electric motor 18.

The blower is arranged so as to blow air through the heating chamber 20 having a heating element 22 therein. The heating element is suitably electrically heated although it is to be appreciated that other forms of heating are also possible.

The heating chamber is constructed so that it directs heated air into the mixing chamber 24 where treatment gas injected into the heated air.

The treatment gas is ozonised air created in the ozoniser assembly 26.

The ozoniser assembly includes an ozoniser 28, and an air pump 29 from which the ozoniser derives its source of air. The supply tube 30 from the ozoniser connects with the mixing chamber 24 wherein the heated stream of air from the blower assembly is mixed with the ozonised air and directed through the split ducting 31 and 32 from whence it passes through the perforated baffle 34.

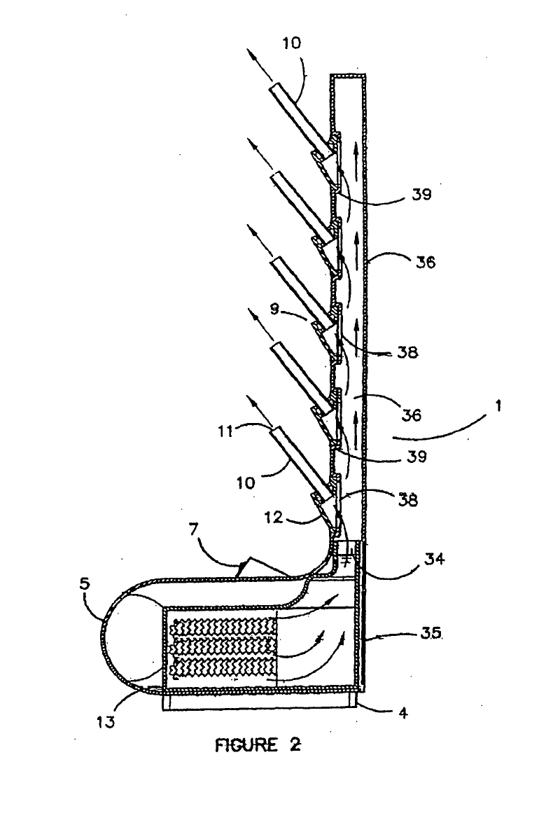

As is shown more clearly in FIG. 2, the blower assembly 13 is a modular unit which can be slipped into the housing 3 by removing the cover 35 at the rear of the housing and simply pushing the blower assembly into the lower part of the housing. The construction is such that the heated ozonised air passing through the baffle 34 is directed into the rear ducting 36 forming the back of the housing and connecting with the nozzle assembly outlets 38 at the forward part of the front vertical face of the housing.

The outlets 38 are formed with a stepped face 39 arranged to locate the nozzle assemblies 9 in line with the lip 40 provided around the frame of each of the nozzle assemblies.

The nozzle assemblies may be removably attached using standard attachment approaches such as screws, bolts or snap fit arrangements.

In an alternative arrangement the front wall 8 of the dryer may be constructed so that the mounting frame 12 forms an integral part of the front wall. This avoids the need for separate nozzle assemblies 9, as shown in FIGS. 1 to 8, which would otherwise need to be individually mounted on the front wall 8.

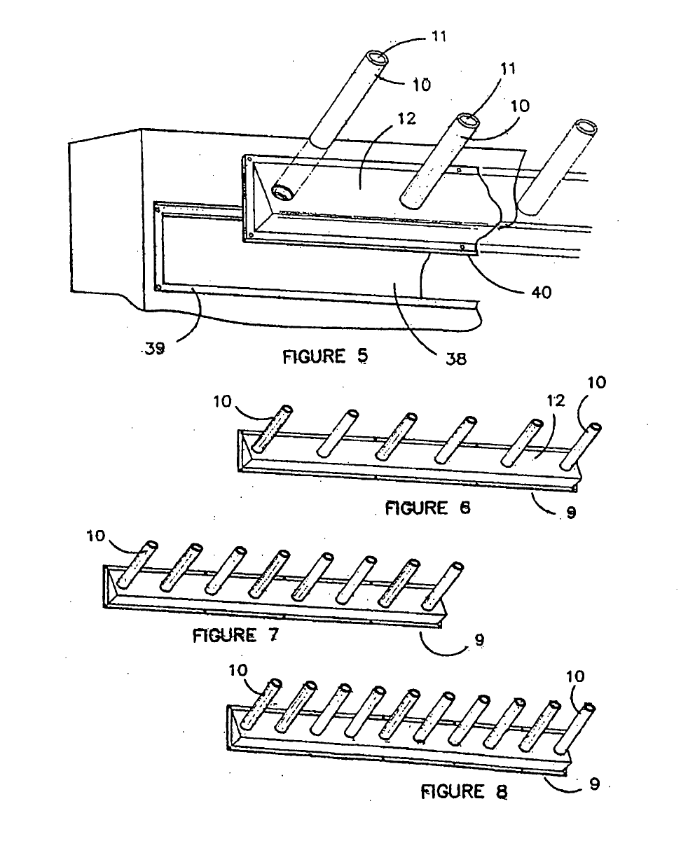

It should be noted that the nozzle assemblies shown in relation to FIGS. 1 to 5, have an arrangement of eight nozzles as is shown in more detail in FIG. 7. It is to be appreciated that fewer nozzles such as the six nozzles of FIG. 6 or more nozzles such as the ten nozzles of FIG. 8 may be substituted as and when required depending on the size of the boots, gloves or shoes being dried and treated by the apparatus.

The fact that the nozzles point upwardly means that it is very easy to simply place the shoes on the nozzles so that the nozzles protrude into the shoes and thereby hold them in place. This has a particular advantage in that hot air, because it tends to rise upwardly, becomes trapped in the shoes thereby maximising the drying power of the hot air.

As there may be times when not all of the nozzles will be covered by shoes, it is preferable that the nozzles be associated with a valve mechanism which switches off flow of heated treatment air therethrough when they are not in use.

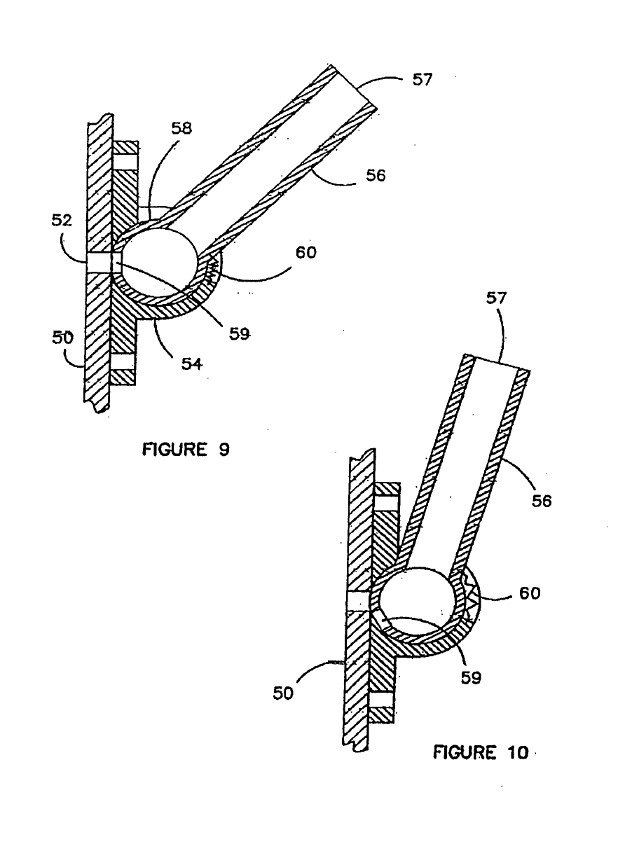

FIGS. 9 to 10 show one example of an arrangement of this sort. In this case, the mounting frame 50 having an inlet 52 includes a socket 54 for receiving a barrel shaped circular end 58 of a nozzle 56.

The circular end is provided with an inlet 59 which lines up with the inlet 52 on the mounting frame when the weight of a shoe pushes the nozzle into the configuration shown in FIG. 9.

However, when there is no weight of a shoe pushing down the nozzle, the spring 60 causes the nozzle to assume the configuration shown in FIG. 10 thereby closing off the inlet 59 and hence stopping the flow of any heated treatment air through the outlet 57 of the nozzle.

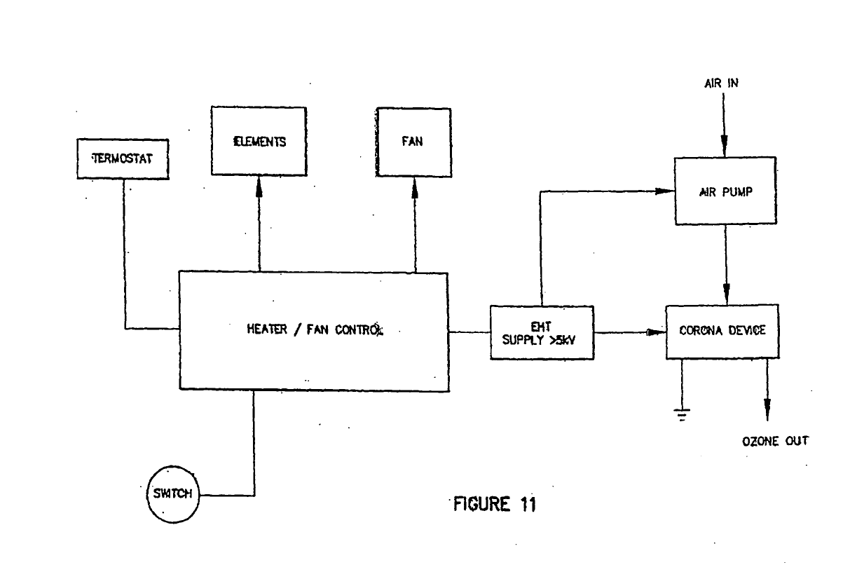

Referring to FIG. 11, the heater/fan control shown therein may comprise a circuit board for controlling the various parameters of the operation of the dryer shown in the preceding Figures. In this regard, the circuit board 27 (see FIG. 4) represented by the heater/fan control in FIG. 11, on activation of the switch, may begin a cycle by activating the fan for an initial period of 3 minutes without the heating elements being switched on.

At the conclusion of 3 minutes, the heater/fan control activates the heating elements and heats the air to a temperature of about 57° C. in accordance with the signals received from the thermostat. Heating continues for about a further 12 minutes while the fan continues to operate for the period of the heating cycle. The heater/fan control switches off the elements and continues the fan for a further 20 seconds at which time the whole system switches off.

The EHT electricity supply to the ozoniser will typically operate within a voltage range of 5,000-50,000 volts, more preferably 7,000-15,000 volts. It will typically comprise a pulsed DC voltage having a frequency between 400 Hz and 5,000 Hz. The heater/fan control starts the ozoniser including the air pump as soon as the dryer is switched on even during the cold cycle and maintains it on until the end of the heating cycle.

The control may arrange to adjust the fan speed so that the air flow through the nozzles falls within the range 8 to 20 ft³ per boot per minute, more preferably 10 to 18 ft³ per boot and more typically 12 ft³ per boot per minute.

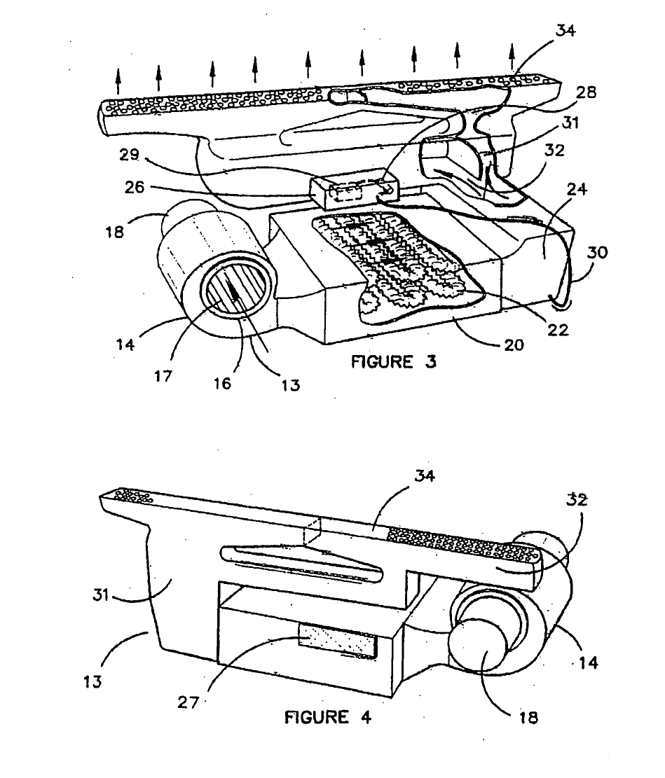

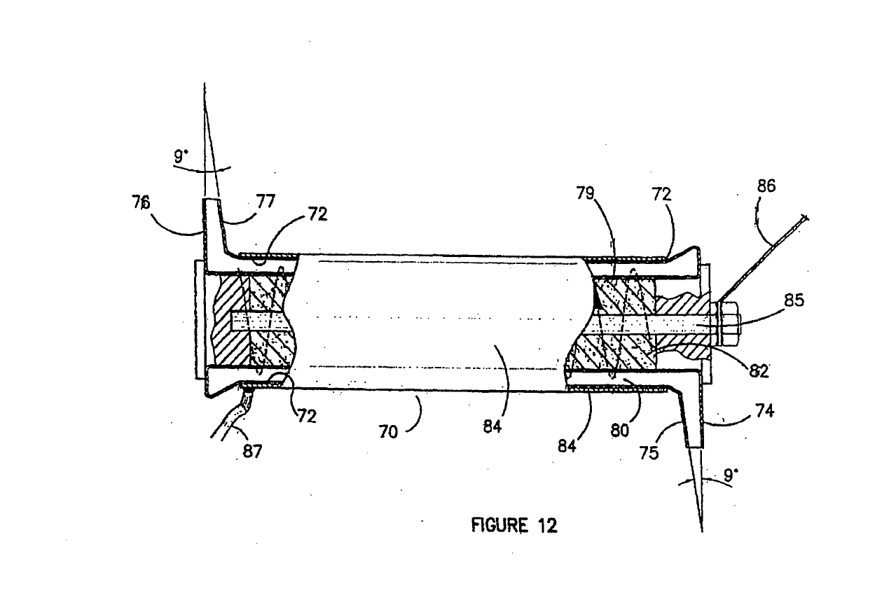

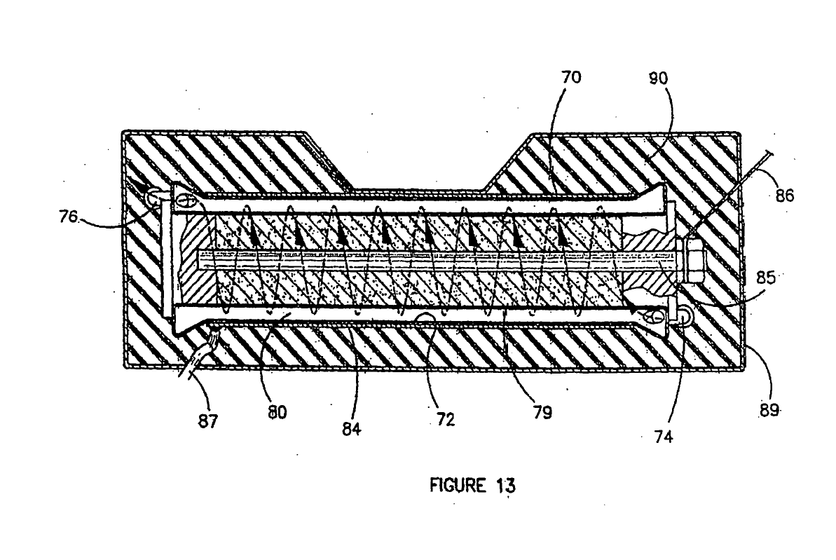

Referring to FIGS. 12 and 13, there is shown an ozoniser 70 which may be used as the ozoniser 28 shown in FIG. 3.

The ozoniser has a tubular housing 72 which may typically comprise glass or similar material.

It includes an inlet 74 having a wall 75 making an angle of 9° with the perpendicular to the axis of the tubular housing ie. the angle of the wall 75 makes an angle of 83° with the axis.

Similarly, the tubular housing at its opposite end has an outlet 76 also having a wall 77 directed at the same angle to the axis.

The ozoniser is provided with a central core 79 arranged so as to provide an annular flow path 80 between the central core and tubular housing. Conductive plastic foam 82 is provided in the central core, the conductive plastic foam surrounding the conductive rod 85 extending along the axis of the tubular housing and central core.

A conductive element 84 surrounds the housing 72. Typically it may comprise a tubular metal element or foil wrapped around the tubular housing. High tension leads 86 and 87 extend to the conductive rod 85 and conductive element 84 respectively.

The ozoniser 70 may itself be housed in an outer container 89 in a layer of insulation 90 surrounding the ozoniser.

Applicants have found that selection of the angle of the inlet and outlet is very important as they have found the efficiency of the ozoniser is greatly effected by changes in this angle.

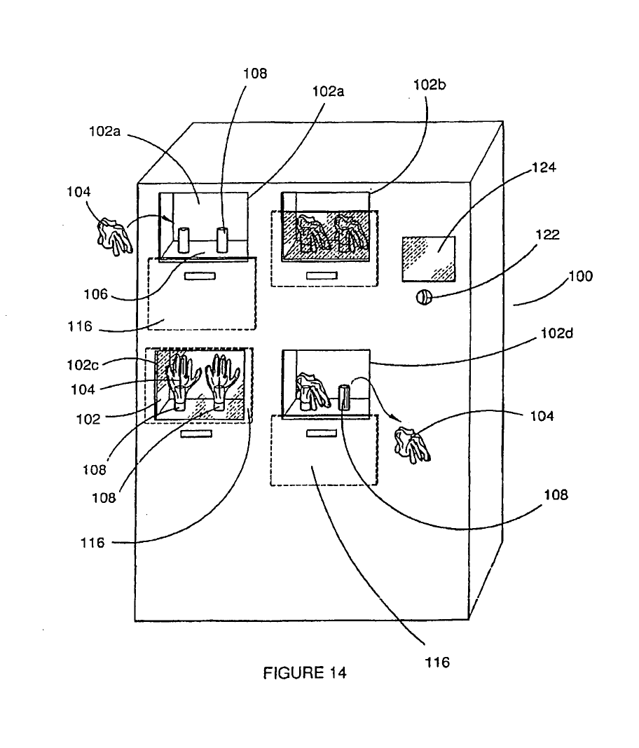

Referring to FIGS. 14 to 17 of the accompanying drawings, there is shown a drying unit 100 which includes four cabinet dryers 102a, b, c and d for gloves 104.

Each cabinet dryer includes a nozzle assembly 106 provided with two nozzles 108 which project upwardly so that one of each of a pair of gloves 104 may be mounted directly onto a respective nozzle.

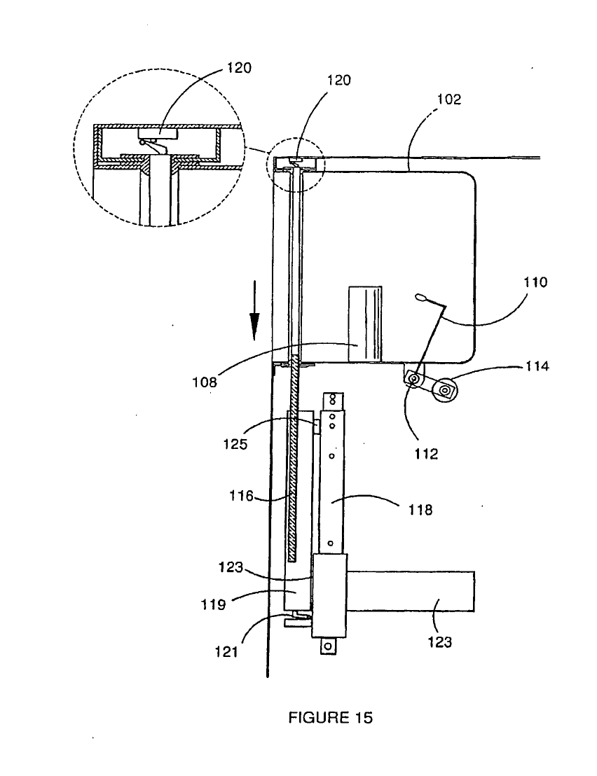

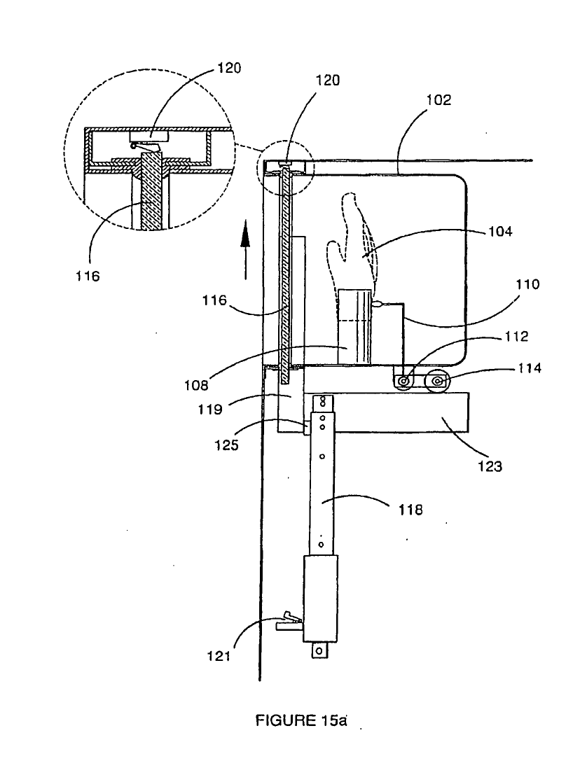

A grip member 110 shown more clearly in profile in FIGS. 15 and 15a, is provided in association with each nozzle 108 and is provided to hold a glove mounted on the nozzle in place on the nozzle when the glove is being dried.

The operation of the grip member is motorized so that it may pivot from the retracted position shown in FIG. 15 to the position in FIG. 15a where it sandwiches the wrist portion of a glove between the tip of the grip member and the nozzle when the glove is put in place to be dried. Thus the grip member includes a pivot point 112 about which it may pivot between the retracted position and an operating position.

Each of the cabinet dryers is provided with a sliding door 116 operated by a linear actuator 118 to individually open or close each cabinet dryer. A switch 120 is provided at the top of each sliding door's travel, to stop the linear actuator pushing the door further once it has reached the top of the cabinet. A similar switch 121 is provided at the bottom of the door's travel.

The sliding door 116 is mounted in the frame assembly 119 which is connected directly to the linear actuator by the sliding arm 123 through the guide 125.

The arrangement of the sliding door is such that movement of the door upwardly from the position shown in FIG. 15 to the closed position shown in FIG. 15a causes the sliding arm 123 to push against the roller wheel 114 thereby pivoting the grip member 110 towards the wrist portion of the glove as the sliding door closes the cabinet.

The drying unit shown generally in FIG. 14 includes a coin, note or credit card operated slot 122 for payment by a user and a display screen 124 which indicates the amount deposited. The display screen may also show when the cabinet dryer is ready for use, the time left remaining for the drying operation to be carried out and stepwise operating instructions.

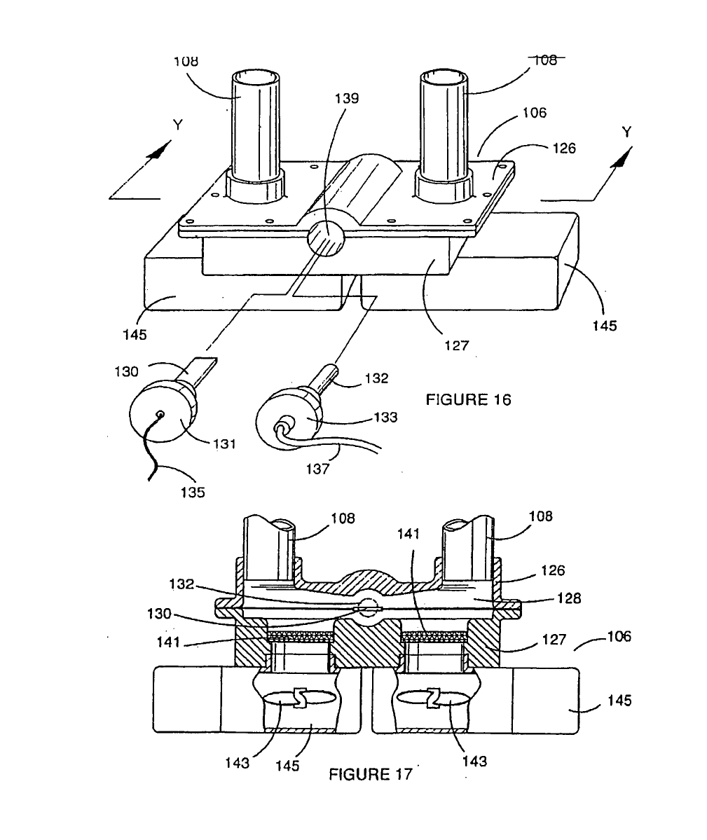

Referring to FIGS. 16 and 17, the nozzle assembly 106 comprises a silicone cover 126 having openings for the two nozzles 108.

A base 127, also of silicone forms a chamber 128 between the two, the chamber communicating with the bottom of each of the nozzles to provide a flow of drying air.

A commercially available ozoniser 130 may be located in the chamber to form ozone in the drying air being directed through the nozzles. Alternatively, a tube 132 connected to an ozoniser of the type described with reference to FIGS. 12 and 13 may provide an alternative source of ozone.

The ozoniser 130 is formed with a plug 131 which can be snugly fitted into the neck 139 formed between the silicone cover 126 and base 127 giving access to the chamber 128. Electrical power for the ozoniser is provided through the electrical leads 135. Alternatively, where a remote ozoniser is connected by the tube 132, the tube is fitted into the neck 139 and held there by the plug 133. The delivery tube 137 delivers ozone to the tube 132.

Ceramic heaters 141 are mounted in the silicone base 127 above fans 143. The fans are arranged to blow air from the air chamber provided with an inlet (not shown) through a respective ceramic heater and vents into the chamber 128 in which the heated air mixes with ozone and is directed through the nozzles 108 into the gloves mounted thereon.

In a typical sequence of operations, a user will approach the drying unit with four cabinet dryers. FIG. 14 shows a typical sequence of operations for drying a pair of gloves. It is to be appreciated that the sequence illustrated across four cabinet dryers will be initiated for each cabinet dryer as it is being used. However, for the purposes of this explanation, it should be assumed that the sequence of steps shown across cabinets 102a to 102d will apply to each individual cabinet dryer when in use.

A microprocessor controls the operations of the four cabinet dryers. It will be programmed so that each cabinet dryer can only be used according to a predetermined sequence. Thus, the first cabinet dryer 102a may initially be presented with its door open if not in use, with the remaining cabinet dryers being closed even though they may not be in use. When the first cabinet dryer is in use, it will be closed and the next cabinet dryer 102b will be available for use, with the remaining cabinet dryers being closed.

Assuming the first cabinet dryer 102a is available to a user, this will be shown on the display 124. The user will place the gloves to be dried on the nozzles and will pay the requisite amount into the machine via the coin/note/credit card slot to activate the drying cycle.

The door 116 closes whilst the grip member for each nozzle pivots towards the wrist portion of each glove to hold the glove securely on the nozzle.

After a period of about 10 to 30 seconds blowing cold air with ozone, heated air with a temperature between 50° C. and 65° C. also having an ozone component is blown through the gloves to dry and deodorize them. The cycle time may typically be, 2 to 10 minutes, more preferably about 2½ to 3½ minutes. After the set drying time, the sliding door 116 retracts, as does the grip member, allowing the user to remove the dried and deodorized gloves.

Whilst gloves are being dried in cabinet dryer 102a, a second user may go through the same process with cabinet dryer 102b and so on.

The microprocessor controlling the functions of the drying unit may be connected by cable or radio to a remote management location. The microprocessor will typically supply information relating to the correct operating parameters of the drying unit as well as the amount of money that the unit has received through the coin/note slot 122.

In a typical scenario, the microprocessor may be associated with a GSM mobile telephone module which may periodically ring and pass on the relevant information logged by the microprocessor to a management facility.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgement or any form of suggestion that such prior art forms part of the common general knowledge in Australia.

1. A dryer comprising,
a motorised air blower for providing a stream of air,
an ozoniser for providing ozone in the stream of air,
a heater for heating the stream of air after a start up period during which the stream of air mixed with ozone is unheated,
a nozzle assembly, each nozzle in the assembly having an outlet, and
ducting for directing the stream of air into the nozzle assembly so that the stream of air exits each nozzle through its outlet.

2. The dryer according to claim 1 wherein the start up period during which the stream of air is not heated is at least 10 seconds.

3. The dryer according to claim 1 comprising a controller for controlling at least one of, the heater, duration of operation of the dryer, rate of flow of the air stream and the degree of ozonization in the stream of air.

4. The dryer according to claim 1 wherein each nozzle in the nozzle assembly is associated with a valve adapted to cut off flow of the stream of air through that nozzle when it is not in use.

5. The dryer according to claim 1 wherein the nozzle assembly is provided in a cabinet closable by a motorized door.

6. The dryer according to claim 5 comprising a plurality of closable cabinets, each cabinet being provided with two nozzles, each nozzle having a grip member for holding a glove on the nozzle.

7. The dryer according to claim 1 comprising a sensor arranged to detect the presence of an object for drying mounted on at least one of the nozzles.

8. The dryer according to claim 5 wherein the controller comprises a microprocessor associated with a currency receiving device, whereby the microprocessor operates a cycle of the dryer when a required amount of currency has been received.

9. The dryer according to claim 8 wherein the microprocessor is arranged to record parameters relating to operation of the dryer chosen from at least one of, the value of currency received by the dryer, temperature of surroundings, drying temperature, operation of safety mechanisms, provision of electrical power and correct functioning of the motorized door.

10. The dryer according to claim 9 wherein the microprocessor is arranged to transmit the recorded parameters by cable or radio to a remote receiving station

11. The dryer according to claim 2 wherein the ozoniser comprises,
a tubular housing of circular cross section having inlet and outlet ends and a central axis,
an inlet tube for oxygen containing gas at the inlet end of the housing,
an outlet tube for ozonised gas at the outlet end of the housing,
an internal core extending axially within the tubular housing to define with the tubular housing, an annular passageway for gas between the inlet tube and outlet tube, and
means for applying a high voltage across the annular passageway,
wherein the inlet is shaped so as to direct a stream of incoming gas into the annular passageway.

12. An ozoniser comprising,
a tubular housing of circular cross section having inlet and outlet ends and a central axis,
an inlet tube for incoming oxygen containing gas at the inlet end of the housing,
an outlet tube for ozonised gas at the outlet end of the housing,
an internal core extending axially within the tubular housing to define with the tubular housing, an annular passageway for gas between the inlet tube and outlet tube, and
means for applying a high voltage across the annular passageway,
wherein the inlet is shaped so as to direct a stream of the incoming gas into the annular passageway.

13. The ozoniser according to claim 12 wherein the stream is directed into the annular passageway at a direction making an angle between 79° and 82° to the central axis.

14. The ozoniser according to claim 12 comprising a core electrode extending along the axis of the core and a conductive electrode surrounding the tubular element.

15. The ozoniser according to claim 12 wherein the means for applying high voltage across the annular passageway are adapted to supply an AC voltage.

16. The ozoniser according to claim 15 wherein the means for applying high voltage are adapted to vary the frequency of AC supply.
